(19) United States
(12) Patent Application Publication
(10) Pub. No.: US 2026/0161155 A1
(43) Pub. Date: Jun. 11, 2026

(54) INFORMATION PROCESSING APPARATUS, SUBSTRATE PROCESSING APPARATUS, AND INFORMATION PROCESSING METHOD

(71) Applicant: Tokyo Electron Limited, Tokyo (JP)

(72) Inventor: Yuya MURAYAMA, Iwate (JP)

(21) Appl. No.: 19/403,122

(22) Filed: Nov. 27, 2025

(30) Foreign Application Priority Data
Dec. 10, 2024 (JP) 2024-215175

(51) Int. Cl. G05B 19/418

(52) U.S. Cl. CPC G05B 19/41875; G05B 2219/32368

(57) ABSTRACT

An information processing apparatus includes a recording control unit that records, in a storage unit, process-system sensor information and transfer-system sensor information when an abnormality occurs, in association with content of the abnormality, and a display control unit that displays, as the log information corresponding to the abnormality, the process-system sensor information and the transfer-system sensor information associated with the content of the abnormality.

### CROSS-REFERENCE TO RELATED APPLICATIONS

This application is based on and claims priority from Japanese Patent Application No. 2024-215175, filed on Dec. 10, 2024, with the Japan Patent Office, the disclosure of which is incorporated herein in its entirety by reference.

### TECHNICAL FIELD

The present disclosure relates to an information processing apparatus, a substrate processing apparatus, and an information processing method.

### BACKGROUND

A substrate processing apparatus includes various types of sensors used for detecting abnormalities or measuring the apparatus state. Information measured by the sensors is recorded as log information in a storage unit inside or outside the substrate processing apparatus. Further, when an abnormality is detected during substrate loading/unloading or during a process, log information at the time of abnormality occurrence such as the time and cause of the abnormality is recorded in the storage. The log information at the time of abnormality occurrence includes information measured by process-system sensors at the time of abnormality occurrence indicating the state of the substrate processing apparatus at the time of abnormality occurrence.

An information processing apparatus that displays historical information necessary for checking the state of a substrate processing apparatus has conventionally been known (see, e.g., Japanese Patent Laid-Open Publication No. 2024-010431).

### SUMMARY

One aspect of the present disclosure is an information processing apparatus including a recording control unit that records, in a storage unit, process-system sensor information and transfer-system sensor information when an abnormality occurs, in association with content of the abnormality, and a display control unit that displays, as the log information corresponding to the abnormality, the process-system sensor information and the transfer-system sensor information associated with the content of the abnormality.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram illustrating an example of a substrate processing system according to the present embodiment.

FIG. 2 is a hardware configuration diagram illustrating an example of a computer.

FIG. 3 is a vertical cross-sectional view schematically illustrating a substrate processing apparatus according to the present embodiment.

FIG. 4 is a functional block diagram illustrating an example of an apparatus controller according to the present embodiment.

FIG. 5 is a flowchart illustrating an example of a processing performed by the apparatus controller according to the present embodiment for recording log information at the time of abnormality occurrence in one or more substrate processing apparatuses.

FIG. 6 is a flowchart illustrating an example of a processing performed by the apparatus controller according to the present embodiment for displaying log information at the time of abnormality occurrence in one or more substrate processing apparatuses.

FIG. 7 is a flowchart illustrating an example of a processing in step S38.

FIG. 8 is an image diagram of an example of an alarm log detail screen.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, the present embodiment will be described with reference to the drawings.

### System Configuration

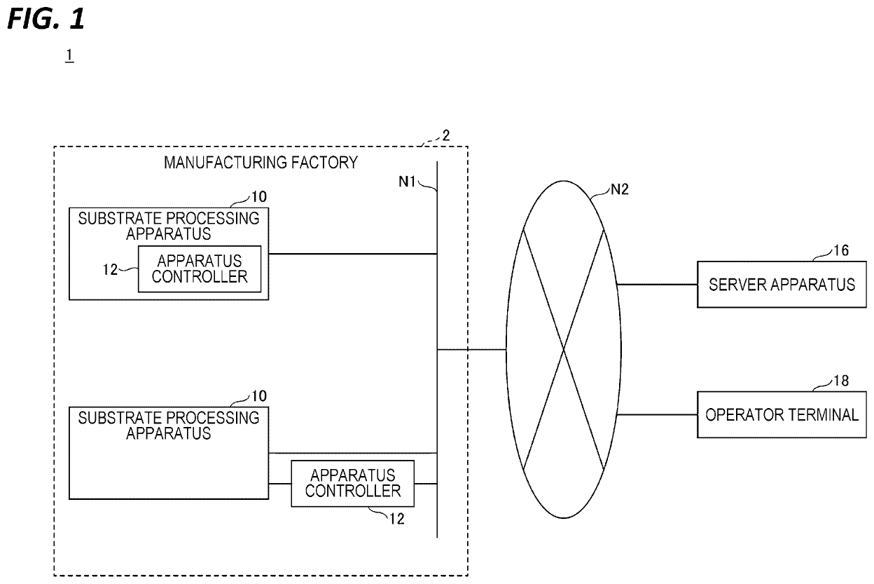

FIG. 1 is a configuration diagram illustrating an example of a substrate processing system 1 according to the present embodiment. The substrate processing system 1 illustrated in FIG. 1 includes a substrate processing apparatus 10, an apparatus controller 12, a server device 16, and an operator terminal 18.

The substrate processing apparatus 10 and the apparatus controller 12 are installed in a manufacturing factory 2. The server device 16 and the operator terminal 18 may be installed either in the manufacturing factory 2 or outside the manufacturing factory 2. The operator terminal 18 is, for example, a Personal Computer (PC) or a smartphone operated by an operator such as an apparatus manager or an analysis engineer in charge of the substrate processing apparatus 10 installed in the manufacturing factory 2.

The substrate processing apparatus 10, the apparatus controller 12, the server apparatus 16, and the operator terminal 18 illustrated in FIG. 1 are communicably connected via networks N1 and N2 such as the Internet or a Local Area Network (LAN).

The substrate processing apparatus 10 is an apparatus that performs processing such as film formation, etching, or ashing, and processes a substrate such as a semiconductor wafer. The substrate processing apparatus 10 is, for example, a semiconductor manufacturing apparatus, a heat treatment apparatus, or a film forming apparatus. The substrate processing apparatus 10 is, for example, a batch-type apparatus or a single-wafer-type apparatus.

The substrate processing apparatus 10 receives control commands (set values), for example, depending on a recipe from the apparatus controller 12, and executes a process. The substrate processing apparatus 10 includes various types of sensors including process-system sensors and transfer-system sensors, which are used for detecting abnormalities or measuring the apparatus state.

The process-system sensors are sensors related to a process, such as a temperature sensor, pressure sensor, and gas flow sensor. The transfer-system sensors are sensors belonging to a mechanical unit. The mechanical unit is, for example, a load port, carrier transfer, wafer transfer, boat transfer, or boat elevator.

The apparatus controller 12 receives instructions for the substrate processing apparatus 10 from the operator. The apparatus controller 12 has a man-machine interface function that provides the operator with information about the substrate processing apparatus 10. The apparatus controller 12 receives information (sensor state) measured by a plurality of sensors provided in the substrate processing apparatus 10, and records the information as log information (historical information) in a storage located inside or outside the substrate processing apparatus 10.

Further, when an abnormality occurs in the substrate processing apparatus 10, the apparatus controller 12 records, in association with the content of the abnormality, sensor information including the state of the process-system sensors (hereinafter referred to as “process-system sensor information”) and sensor information including the state of the transfer-system sensors (hereinafter referred to as “transfer-system sensor information”) at the time of abnormality occurrence as log information at the time of abnormality occurrence (abnormal-time log information) in the storage.

Further, the apparatus controller 12 may also use the process-system sensor information and the transfer-system sensor information for detecting abnormalities in the substrate processing apparatus 10. The apparatus controller 12 displays log information at the time of abnormality occurrence in the substrate processing apparatus 10, as described later.

The apparatus controller 12 illustrated in FIG. 1 is provided for each substrate processing apparatus 10, but may be provided for each group of a plurality of substrate processing apparatuses 10. The apparatus controller 12 may be installed inside a housing of the substrate processing apparatus 10 or outside the housing.

Further, the server apparatus 16 may receive the process-system sensor information and the transfer-system sensor information at the time of abnormality occurrence from a plurality of substrate processing apparatuses 10 in one or more manufacturing factories 2, and may record them as log information at the time of abnormality occurrence in the storage. The server apparatus 16 may also display log information at the time of abnormality occurrence in the substrate processing apparatus 10, as described later. The server apparatus 16 may have a man-machine interface function that provides the operator with a display of log information at the time of abnormality occurrence in the substrate processing apparatus 10 through, for example, a web application.

The operator terminal 18 may also have a man-machine interface function that displays log information at the time of abnormality occurrence in a plurality of substrate processing apparatuses 10 in one or more manufacturing factories 2 through, for example, a web application.

The apparatus controller 12, the server apparatus 16, and the operator terminal 18 are examples of an information processing apparatus that displays log information at the time of abnormality occurrence in the substrate processing apparatus 10. The substrate processing system 1 illustrated in FIG. 1 is merely an example, and various system configuration examples may be employed depending on the application and purpose. The classification of apparatuses such as the apparatus controller 12, the server apparatus 16, and the operator terminal 18 illustrated in FIG. 1 is merely an example. For example, various configurations are possible, such as a configuration in which at least two of the apparatus controller 12, the server apparatus 16, and the operator terminal 18 are integrated, or a configuration in which the functions thereof are further divided.

### Hardware Configuration

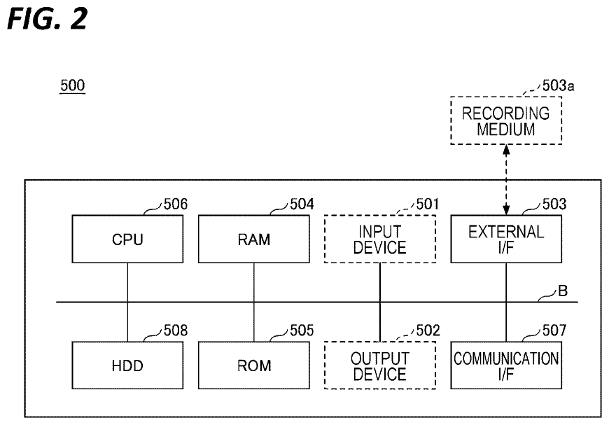

The apparatus controller 12, the server apparatus 16, and the operator terminal 18 illustrated in FIG. 1 may be implemented, for example, by a computer with a hardware configuration illustrated in FIG. 2. FIG. 2 is a hardware configuration diagram illustrating an example of a computer 500.

The computer 500 illustrated in FIG. 2 includes various components such as an input device 501, an output device 502, an external interface (I/F) 503, a Random Access Memory (RAM) 504, a Read Only Memory (ROM) 505, a Central Processing Unit (CPU) 506, a communication I/F 507, and a Hard Disk Drive (HDD) 508, all of which are interconnected via a bus B. The input device 501 and the output device 502 may be connected and used as needed.

The input device 501 may be, for example, a keyboard, mouse, or touch panel, and is used by the operator or other user to input operation signals. The output device 502 may be, for example, a display, and is used to display processing results from the computer 500. The communication I/F 507 is an interface for connecting the computer 500 to the networks N1 and N2 illustrated in FIG. 1. The HDD 508 is an example of a non-volatile storage device that stores programs and data.

The external I/F 503 is an interface for external devices. The computer 500 may read information from a recording medium 503a such as a Secure Digital (SD) memory card via the external I/F 503. The external I/F 503 may also be used to write information to the recording medium 503a such as an SD memory card.

The ROM 505 is an example of a non-volatile semiconductor memory (storage device) in which programs and data are stored. The RAM 504 is an example of a volatile semiconductor memory (storage device) that temporarily holds programs and data. The CPU 506 reads programs and data from a storage device such as the ROM 505 or the HDD 508 into the RAM 504 and executes a processing, thereby functioning as a computation device that performs control and implements the overall functions of the computer 500.

The apparatus controller 12, the server apparatus 16, and the operator terminal 18 of the substrate processing system 1 illustrated in FIG. 1 implement various functions by executing programs on the computer 500 illustrated in FIG. 2.

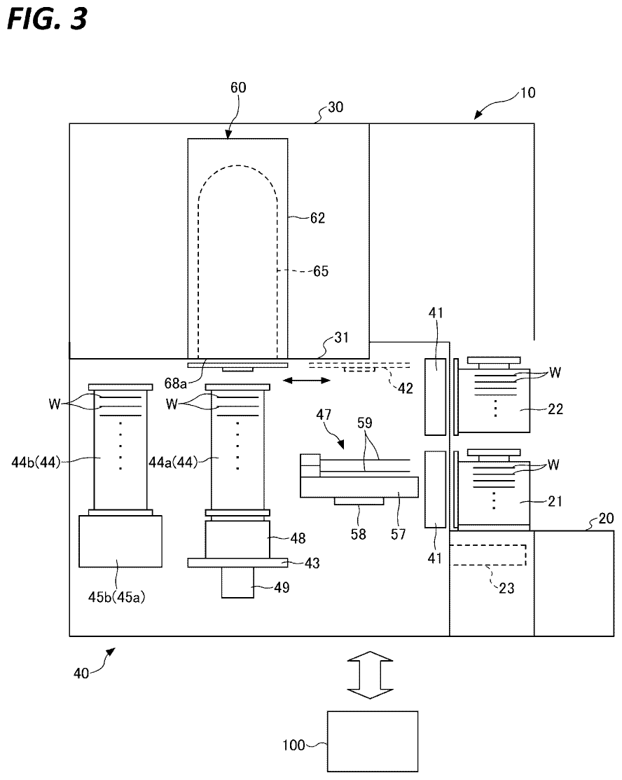

FIG. 3 is a vertical cross-sectional view schematically illustrating the substrate processing apparatus 10 according to the present embodiment. The substrate processing apparatus 10 of FIG. 1 includes a vertical-type heat treatment furnace 60. Wafers W are vertically accommodated and held at predetermined intervals on a boat 44, and may be subjected to various types of heat treatments such as oxidation, diffusion, and reduced-pressure CVD. The following describes an example in which a gas is supplied into a processing container 65, and the surfaces of the wafers W inside the processing container 65 are subjected to heat treatment. The wafer W is an example of a substrate processed by the substrate processing apparatus 10.

The substrate processing apparatus 10 of FIG. 1 includes a placement stand 20, a housing 30, and a controller 100. The placement stand 20 is also referred to as a load port. The placement stand 20 is provided at the front of the housing 30. The housing 30 includes a work area 40 and the heat treatment furnace 60.

The work area 40 is also referred to as a loading area. The work area 40 is formed in a lower portion inside the housing 30. Further, the heat treatment furnace 60 is also referred to as a process area. The heat treatment furnace 60 is provided above the work area 40 inside the housing 30. A base plate 31 is provided between the work area 40 and the heat treatment furnace 60.

The placement stand 20 is used for loading and unloading the wafers W into and from the housing 30. Storage containers 21 and 22 are placed on the placement stand 20. The storage containers 21 and 22 are sealed storage containers (FOUPs) each having a detachable front lid and capable of accommodating a plurality of (e.g., about 25) wafers W at predetermined intervals.

Further, an alignment device 23 may be provided below the placement stand 20 to align cut portions (e.g., notches) formed on the outer peripheries of the wafers W transferred by a transfer mechanism 47 in one direction. The alignment device 23 is also referred to as an aligner.

In the work area 40, the wafers W are transferred between the storage containers 21 and 22 and the boat 44. Further, the boat 44 is loaded into and unloaded from the processing container 65 in the work area 40. The work area 40 is provided with a door mechanism 41, a shutter mechanism 42, a lid 43, the boat 44, bases 45a and 45b, the transfer mechanism 47, a heat-retention cylinder 48, and a lifting mechanism. Illustration of the lifting mechanism is omitted in FIG. 3.

The door mechanism 41 removes lids of the storage containers 21 and 22 to open the storage containers 21 and 22, thereby allowing communication between the work area 40 and the inside thereof. The shutter mechanism 42 is provided above the work area 40 to cover (or close) a furnace opening 68a, in order to reduce or prevent heat from the high-temperature furnace inside from being released into the work area 40 through the furnace opening 68a when the lid 43 is opened.

The lid 43 includes a rotation mechanism 49. The heat-retention cylinder 48 is provided on the lid 43. The boat 44 is provided on the top of the heat-retention cylinder 48. The heat retention cylinder 48 prevents the boat 44 from being cooled by heat transfer to the lid 43, thereby retaining the heat of the boat 44.

The rotation mechanism 49 is attached to the bottom of the lid 43. The rotation mechanism 49 rotates the boat 44. A rotating shaft of the rotation mechanism 49 is provided to airtightly penetrate the lid 43 and rotate a rotary table disposed on the lid 43.

The lifting mechanism vertically drives the lid 43 when loading of the boat 44 from the work area 40 into the processing container 65 and unloading of the boat 44 from the processing container 65 to the work area 40. The lid 43 comes into contact with the furnace opening 68a and seals the furnace opening 68a once the boat 44 raised by the lifting mechanism has been loaded into the processing container 65.

The boat 44 on the lid 43 may rotatably hold the wafers W in a horizontal plane inside the processing container 65. The work area 40 of FIG. 3 is provided with boats 44a and 44b. Further, the work area 40 is provided with the bases 45a and 45b and a boat transfer mechanism. The bases 45a and 45b are placement stands onto which the boats 44a and 44b are transferred from the lid 43, respectively. The boat transfer mechanism transfers the boats 44a and 44b from the lid 43 to the bases 45a and 45b.

The boats 44a and 44b are made of, for example, quartz, and may horizontally accommodate large-diameter wafers W such as those with a diameter of 300 mm at predetermined vertical intervals. Each of the boats 44a and 44b is provided with a plurality of support columns between a top plate and a bottom plate thereof. The support columns are provided with claw portions for holding the wafers W.

The transfer mechanism 47 transfers the wafers W between the storage container 21 or 22 and the boat 44a or 44b. The transfer mechanism 47 includes a base 57, a lifting arm 58, and a plurality of transfer plates 59. The transfer plates 59 are also referred to as forks.

The base 57 is provided to be vertically liftable and rotatable. The lifting arm 58 is provided to be movable (liftable) in the vertical direction by means of a ball screw and others. The base 57 is provided on the lifting arm 58 to be horizontally rotatable.

The heat treatment furnace 60 includes a jacket 62, the processing container 65, and a heater. Illustration of the heater is omitted.

The processing container 65 accommodates the wafers W held by the boat 44. The wafers W accommodated in the processing container 65 are subjected to heat treatment. The processing container 65 is made of, for example, quartz and has a vertically elongated shape. A gas is supplied to the processing container 65 through an injector. Further, the gas supplied into the processing container 65 is discharged from an exhaust system.

The jacket 62 is provided to cover the periphery of the processing container 65, and also defines a space around the processing container 65. The jacket 62 has a cylindrical shape, similar to the processing container 65.

The heater is provided inside the jacket 62 to cover the periphery of the processing container 65. The heater is capable of heating and controlling the processing container 65 to a predetermined temperature (e.g., 50° C. to 1,200° C.). The heater heats the wafers W accommodated in the processing container 65.

The substrate processing apparatus 10 includes a process-system sensor and a transfer-system sensor. For example, the heat treatment furnace 60 is provided with a temperature sensor (such as a thermocouple), which is the process-system sensor. The work area 40 is provided with the transfer-system sensor. Information measured by the process-system sensor and the transfer-system sensor is input to the controller 100. The controller 100 may be common with the apparatus controller 12. The controller 100 controls a processing of the substrate processing apparatus 10 using information measured by the process-system sensor and the transfer-system sensor.

The controller 100 is implemented, for example, by the computer 500 as described above. The controller 100 reads a program recorded in a storage device, and sends control signals to various components constituting the substrate processing apparatus 10 according to the program to perform a substrate processing.

### Functional Configuration

In the following, an example will be described in which the information processing apparatus configured to display log information at the time of abnormality occurrence in the substrate processing apparatus 10 is the apparatus controller 12. The information processing apparatus configured to display log information at the time of abnormality occurrence in the substrate processing apparatus 10 may be the server device 16 or the operator terminal 18.

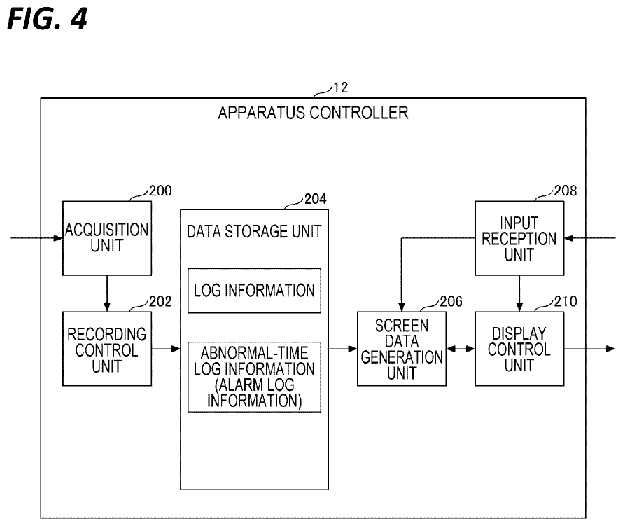

The apparatus controller 12 of the substrate processing system 1 according to the present embodiment is implemented, for example, by functional blocks as illustrated in FIG. 4. FIG. 4 is a functional block diagram illustrating an example of the apparatus controller 12 according to the present embodiment. Illustration of configurations that are unnecessary for the description of the present embodiment is omitted from the functional block diagram of FIG. 4.

The apparatus controller 12 of FIG. 4 implements an acquisition unit 200, a recording control unit 202, a data storage unit 204, a screen data generation unit 206, an input reception unit 206, and a display control unit 210 by executing a program for the apparatus controller 12.

The acquisition unit 200 acquires process-system sensor information and transfer-system sensor information from the process-system sensor and the transfer-system sensor provided in the substrate processing apparatus 10. Further, the acquisition unit 200 may acquire information indicating that an abnormality has occurred in the substrate processing apparatus 10 from the outside of the apparatus controller 12.

The recording control unit 202 records the process-system sensor information and the transfer-system sensor information acquired by the acquisition unit 200 as log information in the data storage unit 204. The recording control unit 202 records, in association with the content of the abnormality occurred in the substrate processing apparatus 10, the process-system sensor information and the transfer-system sensor information at the time of abnormality occurrence, as abnormal-time log information in the data storage unit 204. The abnormal-time log information is also referred to as alarm log information.

In this way, the data storage unit 204 stores both log information recorded as needed and abnormal-time log information recorded at the time of abnormality occurrence. Since the number of log information entries recorded as needed is greater than that of abnormal-time log information entries recorded at the time of abnormality occurrence, the storage period for the log information recorded as needed is often shorter than that for the abnormal-time log information.

The input reception unit 208 receives various operations from the operator. The operations received from the operator include an application start-up operation, various operations on the started application, and others. The input reception unit 208 notifies the screen data generation unit 206 and the display control unit 210 of the contents of various operations received from the operator.

The screen data generation unit 206 reads log information of the substrate processing apparatus 10 or the abnormal-time log information recorded in the data storage unit 204 based on the contents of various operations received from the operator. The screen data generation unit 206 generates screen data for a screen to be described later, and transmits the screen data to the display control unit 210.

The display control unit 210 causes the screen described later to be displayed on the output device 502 according to the screen data received from the screen data generation unit 206 and the contents of various operations performed by the operator as notified from the input reception unit 208.

### Processing

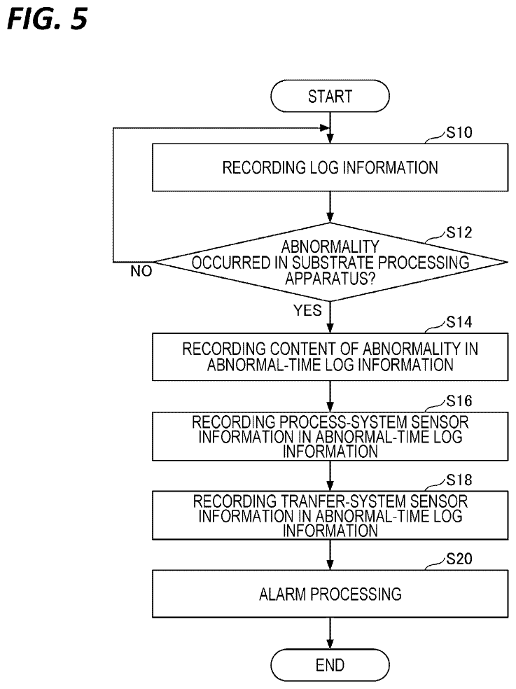

FIG. 5 is a flowchart illustrating an example of a processing performed by the apparatus controller 12 according to the present embodiment for recording log information at the time of abnormality occurrence in one or more substrate processing apparatuses 10.

In step S10, the acquisition unit 200 of the apparatus controller 12 acquires process-system sensor information and transfer-system sensor information from the process-system sensor and the transfer-system sensor provided in the substrate processing apparatus 10. Further, the recording control unit 202 records the process-system sensor information and the transfer-system sensor information acquired by the acquisition unit 200 as log information in the data storage unit 204.

In step S12, when no abnormality has occurred in the substrate processing apparatus 10, the recording control unit 202 of the apparatus controller 12 returns to the processing of step S10 and continues recording the log information. When an abnormality has occurred in the substrate processing apparatus 10, the recording control unit 202 proceeds to the processing of step S14.

In step S14, the recording control unit 202 records the content of the abnormality occurred in the substrate processing apparatus 10 in the abnormal-time log information of the data storage unit 204.

In step S16, the recording control unit 202 records, in association with the content of the abnormality recorded in the abnormal-time log information of the data storage unit 204, the process-system sensor information at the time of abnormality occurrence in the abnormal-time log information of the data storage unit 204.

In step S18, the recording control unit 202 records, in association with the content of the abnormality recorded in the abnormal-time log information of the data storage unit 204, the transfer-system sensor information at the time of abnormality occurrence in the abnormal-time log information of the data storage unit 204.

In step S20, the apparatus controller 12 performs an alarm processing based on the abnormality occurred in the substrate processing apparatus 10. The alarm processing performed by the apparatus controller 12 may be a processing of displaying the occurrence of the abnormality on the screen of the apparatus controller 12, or may be a processing of issuing an alarm.

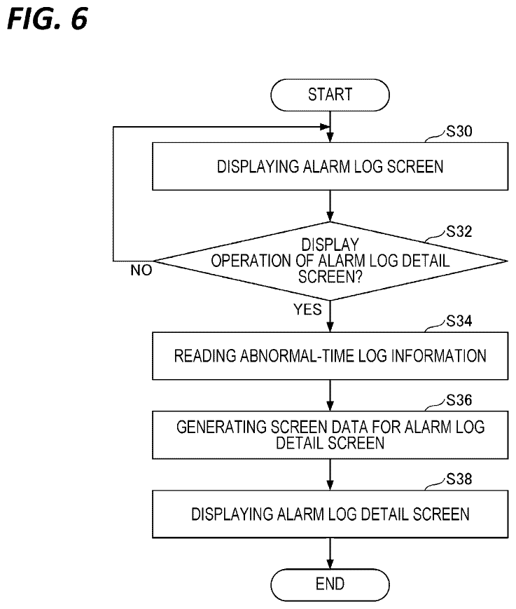

FIG. 6 is a flowchart illustrating an example of a processing performed by the apparatus controller 12 according to the present embodiment for displaying log information at the time of abnormality occurrence in one or more substrate processing apparatuses 10.

In step S30, the input reception unit 208 of the apparatus controller 12 receives a display operation of an alarm log screen from the operator. The screen data generation unit 206 of the apparatus controller 12 reads the abnormal-time log information of the substrate processing apparatus 10 recorded in the data storage unit 204, and generates screen data for the alarm log screen. The display control unit 210 of the apparatus controller 12 causes the alarm log screen to be displayed, for example, on the output device 502 according to the alarm log screen generated by the screen data generation unit 206.

The alarm log screen includes, for example, a list in which the content of an abnormality occurred in the substrate processing apparatus 10 is displayed. The alarm log screen is an example of a screen for displaying the content of an abnormality. The alarm log screen is provided with a button and others for receiving a display operation of an alarm log detail screen from the operator.

In step S32, when the input reception unit 208 has not received the display operation of the alarm log detail screen from the operator, it returns to the processing of step S30, and continues to display the alarm log screen.

When the input reception unit 208 has received the display operation of the alarm log detail screen from the operator, it proceeds to the processing of step S34, and the screen data generation unit 206 reads the abnormal-time log information of the substrate processing apparatus 10 recorded in the data storage unit 204.

In step S36, the screen data generation unit 206 generates screen data for the alarm log detail screen using the abnormal-time log information of the substrate processing apparatus 10 read from the data storage unit 204 in step S34. The alarm log detail screen is a screen including the process-system sensor information and the transfer-system sensor information at the time of abnormality occurrence in the substrate processing apparatus 10.

In step S38, the display control unit 210 of the apparatus controller 12 displays the alarm log detail screen according to the screen data generated in step S36. The display control unit 210 may display the transfer-system sensor information obtained when an abnormality occurred while the substrate processing apparatus 10 was executing a substrate process in the process area.

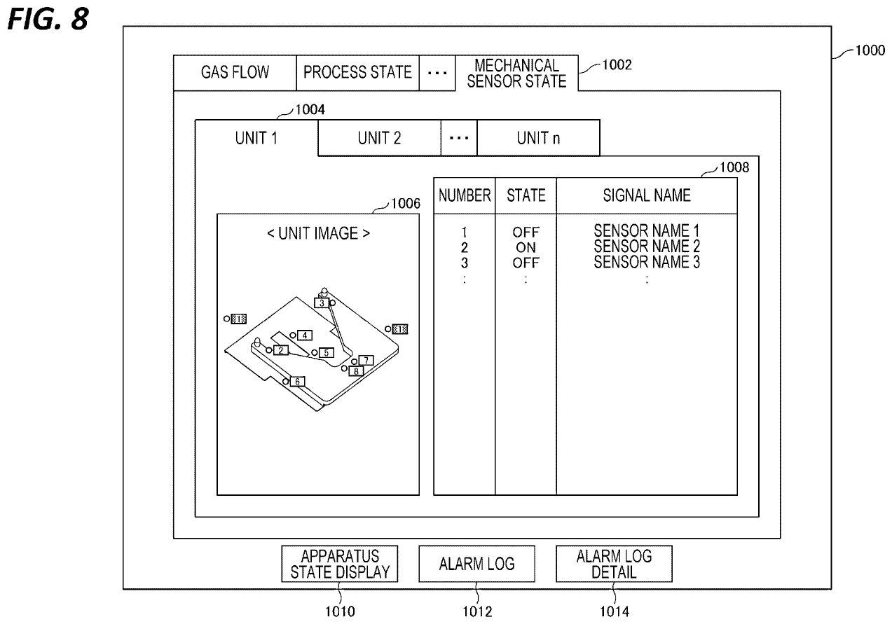

FIG. 8 is an image diagram of an example of the alarm log detail screen. The alarm log detail screen 1000 of FIG. 8 illustrates an example of a screen in which a mechanical sensor state tab 1002 is selected. The alarm log detail screen 1000, in which the mechanical sensor state tab 1002 is selected, displays a unit tab 1004 corresponding to each mechanical unit, which is an example of a unit of the transfer-system.

The operator may switch and check the display of a unit image 1006 and transfer-system sensor information 1008 on the alarm log detail screen 1000 by switching the unit tab 1004.

The unit image 1006 displays an image representing the shape of the mechanical unit selected by the unit tab 1004, the position of the transfer-system sensor belonging to the unit, and the sensor number. In FIG. 8, an image representing the shape of a load port, which is an example of the mechanical unit, is displayed.

The transfer-system sensor information 1008 displays the sensor information of the transfer-system sensor belonging to the mechanical unit selected by the unit tab 1004. In FIG. 8, the sensor number, state, and signal name (sensor name) of the transfer-system sensor belonging to the mechanical unit selected by the unit tab 1004 are displayed. The sensor number displayed in the unit image 1006 corresponds to the sensor number displayed in the transfer-system sensor information 1008.

By displaying the alarm log detail screen 1000 of FIG. 8, the operator may check the transfer-system sensor information 1008 at the time when an abnormality occurred in the substrate processing apparatus 10 while referring to the unit image 1006.

Further, by displaying the alarm log detail screen 1000 of FIG. 8, the operator may switch the unit tab 1004 and refer to the transfer-system sensor information 1008 at the time when an abnormality occurred in the substrate processing apparatus 10 for each unit of the transfer-system unit.

Furthermore, the operator may display the process-system sensor information at the time when an abnormality occurred in the substrate processing apparatus 10 by selecting a gas flow tab or a process state tab of the alarm log detail screen 1000 of FIG. 8.

The alarm log detail screen 1000 of FIG. 8 includes a device state display button 1010, an alarm log button 1012, and an alarm log detail button 1014.

The alarm log button 1012 is a button for receiving a display operation of the alarm log screen from the operator. The alarm log detail button 1014 is a button for receiving a display operation of the alarm log detail screen 1000 from the operator. The device state display button 1010 is a button for receiving a display operation of a screen showing current transfer-system sensor information from the operator.

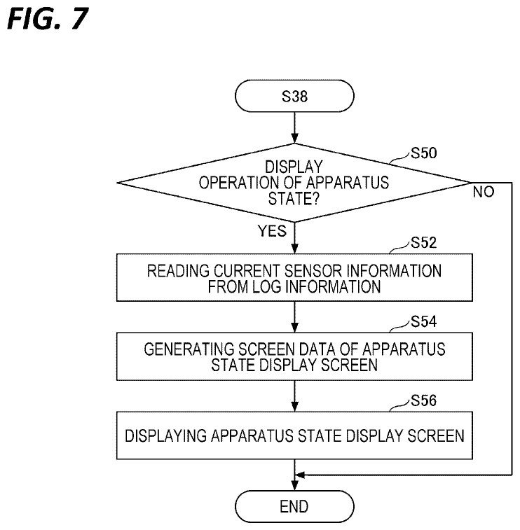

In step S38 of FIG. 6, the display control unit 210 of the apparatus controller 12 may perform a screen transition from the alarm log detail screen 1000 to the screen for displaying the current transfer-system sensor information according to the processing procedure as illustrated in FIG. 7.

FIG. 7 is a flowchart illustrating an example of a processing in step S38.

When the input reception unit 208 of the apparatus controller 12 receives a display operation of the screen showing the current transfer-system sensor information from the operator, it proceeds to the processing of step S52. When the input reception unit 208 of the apparatus controller 12 does not receive the display operation of the screen showing the current transfer-system sensor information from the operator, the flowchart processing of FIG. 7 is terminated.

In step S52, the screen data generation unit 206 of the apparatus controller 12 reads current sensor information from the log information recorded in the data storage unit 204. The screen data generation unit 206 may also acquire the current sensor information from the acquisition unit 200.

In step S54, the screen data generation unit 206 generates screen data for a device state display screen from the current sensor information. In step S56, the display control unit 210 displays the device state display screen.

The device state display screen generated from the current sensor information includes the current transfer-system sensor information. The display control unit 210 may facilitate comparison between the transfer-system sensor information at the time of abnormality occurrence and the current transfer-system sensor information by combining the configuration of the alarm log detail screen 1000 illustrated in FIG. 8, which includes the transfer-system sensor information at the time of abnormality occurrence, with the configuration of the device state display screen, which includes the current transfer-system sensor information.

### Summary

In general, abnormal-time log information recorded at the time of abnormality occurrence has mainly focused on process-system sensor information since abnormalities directly related to substrate defects have been regarded as critical. In the meantime, transfer-system sensor information, which includes information on substrate loading and unloading, is recorded as regular log information on an ongoing basis but has not been recorded as abnormal-time log information.

However, recently, there have been cases where no abnormality may be found even after analyzing the process-system sensor information at the time of abnormality occurrence, which is recorded in the abnormal-time log information, thereby creating situations where the transfer-system sensor information is also needed for analysis. For example, although it may be possible to resolve an abnormality by analyzing the transfer-system sensor information from the regularly recorded log information, this requires expert knowledge to analyze the relevant transfer-system sensor information from the log information, resulting in a prolonged troubleshooting time.

Furthermore, since the storage period of the regularly recorded log information tends to be shorter than that of the abnormal-time log information, the longer the time between the occurrence of an anomality and the analysis thereof, the higher the likelihood that the necessary transfer-system sensor information will have already been lost by the time of analysis.

Accordingly, in the present embodiment, the alarm log detail screen 1000, which allows the operator to refer to sensor information at the time of abnormality occurrence in the substrate processing apparatus 10, is configured to display both the process-system sensor information and the transfer-system sensor information at the time of abnormality occurrence. In this way, according to the present embodiment, in the alarm log detail screen 1000 accessible from the alarm log screen, the operator may refer not only to the process-system sensor information at the time of abnormality occurrence but also to the transfer-system sensor information at the time of abnormality occurrence.

Furthermore, in the present embodiment, by combining the configuration of the alarm log detail screen 1000, which displays the transfer-system sensor information at the time of abnormality occurrence, with the configuration of the device status display screen, which displays the current transfer-system sensor information, comparison between the state of the transfer-system sensor at the time of abnormality occurrence and the latest transfer-system sensor state is facilitated.

In the present embodiment, for example, the cause of an abnormality in the substrate processing apparatus 10 may be identified in situations as those described below.

A first situation is an example in which, during carrier transfer by a carrier transfer, an alarm occurs and the carrier transfer operation stops because a sensor detects an obstacle on the transfer path, but checking the current sensor state reveals no abnormality. In the first situation, when the operator refers to the sensor information of the transfer-system at the time of occurrence of the alarm, the sensor on the transfer path is an ON state, and the operator may thereby identify the sensor responsible for the alarm. The operator may then check the identified sensor and detect a failure of that sensor.

A second situation is an example in which, during wafer transfer by a wafer transfer unit, an alarm indicating a state abnormality occurs and the transfer operation stops due to inconsistency in wafer information on a fork, but the state of the current wafer-presence sensor indicates that the material is accurately present. In the second situation, by referring to the transfer-system sensor information at the time of occurrence of the alarm, the operator may identify that a wafer-presence sensor on a specific fork is in an OFF state, thus specifying the problematic fork. The operator may then check an air supply valve for the specific fork and detect a failure caused by reduced air supply pressure, which weakened the wafer-chucking force and made wafer detection difficult.

Thus, according to the present embodiment, since the transfer-system sensor information at the time of abnormality occurrence may be referred to on the alarm log detail screen 1000 accessible from the alarm log screen, it is possible to more accurately check the state of the substrate processing apparatus 10 at the time of abnormality occurrence.

According to the present embodiment, in a case where the location of an abnormality is identified after a considerable amount of time has passed since the occurrence of the abnormality, even when the process-system sensor information alone may not reveal the abnormality and thus it is difficult to identify the location of the abnormality, the location of the abnormality may still be identified with higher likelihood. Further, according to the present embodiment, since the transfer-system sensor information is recorded as part of the abnormal-time log information in association with the abnormality content, it is possible to avoid the risk of losing the transfer-system sensor information before abnormality analysis. According to the present embodiment, even when there is a time gap between the occurrence of the abnormality and the analysis thereof, it is possible to avoid a situation in which there is no transfer-system sensor information necessary for analysis.

The substrate processing apparatus 10 illustrated in FIG. 3 is an example of a batch-type apparatus. The batch-type substrate processing apparatus 10 is an example of an apparatus capable of transferring another substrate from the loading area while a substrate process is being executed in the process area.

In the batch-type substrate processing apparatus 10, for example, when an abnormality occurs in a unit within the loading area while a processing of one substrate is in progress in the process area, an alarm may be issued only after the process in the process area has been completed. In such a case, although there is a time gap between the occurrence and analysis of the abnormality, since the transfer-system sensor information at the time of abnormality occurrence may be referred to on the alarm log detail screen 1000 accessible from the alarm log screen, it is possible to more accurately check the state of the substrate processing apparatus 10 at the time of abnormality occurrence.

According to the substrate processing system 1 of the present embodiment, it is possible to improve the ease of identifying the cause of an abnormality occurred in the substrate processing apparatus 10.

The substrate processing apparatus 10 of the present disclosure may be applied to any type of apparatus such as an Atomic Layer Deposition (ALD) apparatus, a Capacitively Coupled Plasma (CCP) apparatus, an Inductively Coupled Plasma (ICP) apparatus, a Radial Line Slot Antenna (RLSA) apparatus, an Electron cyclotron Resonance plasma (ECR) apparatus, or a Helicon Wave Plasma (HWP) apparatus. The substrate processing apparatus 10 of the present disclosure may also be applied to a Chemical Vapor Deposition (CVD) apparatus and an oxidation/annealing apparatus.

Needless to say, the substrate processing system 1 of the present disclosure is not limited to the configuration illustrated in FIG. 1, and various system configuration examples may be adopted according to the intended use and purpose. The substrate processing apparatus 10 of the present disclosure may be applied to any of a single-wafer type substrate processing apparatus that processes substrates one by one and a batch-type or semi-batch type substrate processing apparatus that processes multiple substrates at once. Examples of processes performed by the substrate processing apparatus 10 of the present disclosure may include film formation and etching.

According to the present disclosure, it is possible to provide a technique for displaying transfer-system sensor information at the time of abnormality occurrence in a substrate processing apparatus as log information at the time of abnormality occurrence.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
a recording controller configured to record, in a storage, process-system sensor information and transfer-system sensor information when an abnormality occurs in a substrate processing apparatus, in association with content of the abnormality; and
a display controller configured to display, as log information corresponding to the abnormality, the process-system sensor information and the transfer-system sensor information associated with the content of the abnormality.

2. The information processing apparatus according to claim 1, wherein the recording controller records, in the storage, sensor information including a state of a transfer-system sensor when the abnormality occurs, and
the display controller transitions from a screen displaying the content of the abnormality to a screen displaying the sensor information including the state of the transfer-system sensor when the abnormality occurs.

3. The information processing apparatus according to claim 2, wherein the display controller displays the sensor information including the state of the transfer-system sensor for each unit of a transfer system.

4. The information processing apparatus according to claim 1, wherein the display controller aligns a configuration of a screen displaying, in associated with the content of the abnormality, the transfer-system sensor information when the abnormality occurs, with a configuration of a screen that displays current transfer-system sensor information.

5. The information processing apparatus according to claim 1, wherein the display controller displays the transfer-system sensor information obtained when the abnormality occurs while the substrate processing apparatus executes a substrate process in a process area.

6. A substrate processing apparatus comprising:
a recording controller configured to record, in a storage, process-system sensor information and transfer-system sensor information when an abnormality occurs; and
a display controller configured to display, as the log information corresponding to the abnormality, the process-system sensor information and the transfer-system sensor information associated with the content of the abnormality.

7. The substrate processing apparatus according to claim 6, wherein, while executing a process on one substrate in the process area, another substrate is transferable in a loading area.

8. An information processing method comprising:
recording, in a storage, process-system sensor information and transfer-system sensor information when an abnormality occurs in a substrate processing apparatus, in association with content of the abnormality; and
displaying, as the log information corresponding to the abnormality, the process-system sensor information and the transfer-system sensor information associated with the content of the abnormality.
